(19) United States
(12) Patent Application Publication
(10) Pub. No.: US 2010/0146048 A1
(43) Pub. Date: Jun. 10, 2010

(54) SOCIAL NETWORK SYSTEMS AND METHODS

(76) Inventor: Russell Rothstein, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/562,492

(22) Filed: Sep. 18, 2009

Related U.S. Application Data
(60) Provisional application No. 61/120,535, filed on Dec. 8, 2008.

(30) Foreign Application Priority Data
May 4, 2009 (CA) 2665282

(51) Int. Cl. G06F 15/16; G06F 7/00

(52) U.S. Cl. 709/204; 707/E17.044

(57) ABSTRACT

Social network systems and methods are disclosed. The system includes at least one computer which provides content to a first group of members and a second group of members. A first portion of the content is associated with a first social network and a second portion of the content is associated with a second social network. The first social network is associated with a first entity, and the first group of members. The first portion of the content includes first member-generated content. The second social network is associated with a second entity and the second group of members. The second portion of the content includes second member-generated content. The computer provides to the first group of members: (i) the first member-generated content, and (ii) at least a portion of the second member-generated content.

### CROSS-REFERENCE TO RELATED APPLICATIONS

This application claims priority from U.S. Provisional Patent Application 61/120,535, filed on Dec. 8, 2008, which is incorporated herein by reference in its entirety.

### TECHNICAL FIELD

The present invention relates to social networks. In particular, the invention relates to business social networks.

### BACKGROUND

Social networks can generally be described as web-based services that allow members of a particular social network to connect and interact with other members of the social network. Social networks typically fall into one of two categories: public social networks; or corporately branded business social networks.

Public or consumer social networks typically focus on building online communities of people who share interests and activities, or who are interested in exploring the interests and activities of others. These social networks typically provide a variety of ways for members to interact, such as e-mail and instant messaging services. Examples of public social networks include MySpace™, Facebook™, Bebo™, Hi5™, Orkut™, Friendster™ and Cyworld™.

Corporately branded business social networks are social networks set-up by a private organization, such as a corporation. These social networks often act as a customer relationship management tool for companies selling products and services. These social networks can also be used by recruiters and human resource departments for hiring new employees. In addition, since many companies operate globally, these types of social networks can make it easier to keep in touch with contacts around the world.

Driven by market and competitive pressure, enterprises are looking to quickly launch corporate social networks. However, many corporate social networks struggle at start-up because they are devoid of members and member generated content.

### SUMMARY

According to a first embodiment of the invention, a social network system is provided. The system comprises at least one computer adapted to provide content to a first plurality of members and a second plurality of members. A first portion of the content is associated with a first social network and a second portion of the content is associated with a second social network. The first social network is associated with a first entity, and the first plurality of members. The first portion of the content comprises first member-generated content. The second social network is associated with a second entity and the second plurality of members. The second portion of the content comprises second member-generated content. The computer is adapted to provide to the first plurality of members: (i) the first member-generated content, and (ii) at least a portion of the second member-generated content.

According to a second embodiment of the invention, a method of providing content to a user is provided. The method comprises:
a) receiving identifying information from the user;
b) using the identifying information to identify the user as a member of a first social network, wherein the first social network is associated with a first member-generated content; and
c) sending to the user the first member-generated content from the first social network and at least a portion of a second member-generated content associated with a second social network.

According to a third embodiment of the invention, a method of accessing content by a user is provided. The method comprises:
a) sending a request for content to a computer, wherein the request comprises identifying information, wherein the identifying information is adapted to identify the user as a member of a first social network, wherein the first social network is associated with a first member-generated content; and
b) receiving on a member device of the user the first member-generated content from the first social network and at least a portion of a second member-generated content associated with a second social network.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a hybrid social network system in accordance with at least one embodiment;

FIG. 2 is a block diagram of the hybrid social network service provider computing system of FIG. 1 in accordance with at least one embodiment;

FIG. 3 is a block diagram illustrating the distribution of content in the hybrid social network system of FIG. 1 in accordance with at least one embodiment;

FIG. 4A is an illustration of a general home page for a hybrid social network in accordance with at least one embodiment;

FIG. 4B is an illustration of a registration page for a hybrid social network in accordance with at least one embodiment;

FIG. 4C is an illustration of a member home page for a hybrid social network in accordance with at least one embodiment; and

FIG. 5 is a flowchart of a method for delivering content to a member of a hybrid social network in accordance with at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

Generally, the terms “member” and “user” are used interchangeably throughout this description.

The described embodiments relate to an improved social network, herein referred to as a hybrid social network. According to an embodiment of the present invention, the hybrid social network combines the content sharing and global user aspects of a public social network, with the private branding of a corporately branded business social network. The hybrid social network is associated with any suitable entity, such as a corporation or other owner of the hybrid social network.

In at least one embodiment, the members of a particular hybrid social network have the ability to interact or communicate not only with each other, but also with members of any other hybrid social network hosted by the same hybrid social network service provider. The members of a particular hybrid social network may also have access, not only to content created by the corporation or owner of the hybrid social network, but also to content generated by members of other hybrid social networks hosted by the same hybrid social network service provider.

Advantages of the hybrid social network over traditional corporately branded business social networks include advanced time to market and seamless integration of the user and content with the brand in question. Specifically, since the hybrid social network starts with an instant user-based community (i.e. the members of the other hybrid social networks hosted by the same hybrid social network service provider) and instant pre-populated user-generated content, hybrid social networks may avoid the problems typically associated with the start-up of a new corporately branded social network.

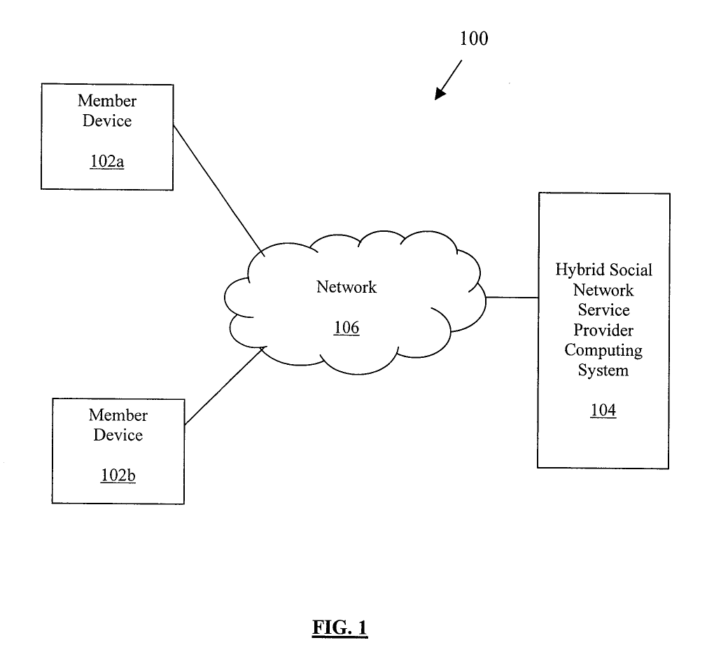

Reference is now made to FIG. 1, in which a hybrid social network system 100 in accordance with an embodiment is illustrated. The hybrid social network system 100 includes member devices 102a and 102b connected to a hybrid social network service provider computing system 104 via a network 106. A member uses the member device 102a or 102b to access and participate in one or more hybrid social networks, which are hosted on the hybrid social network service provider computing system 104.

Each member device 102a or 102b is preferably implemented by the use of one or more general purpose computers, such as, for example, a typical personal computer manufactured by Dell™, Gateway™, or Hewlett-Packard™. Those skilled in the art will understand that the member devices 102a and 102b may be a laptop computer, a personal digital assistant (PDA), a mobile phone, a set top box, an interactive television or the like.

The member devices 102a and 102b may include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof.

The member devices 102a and 102b can also include computer memory, such as, for example, random-access memory (RAM). However, the computer memory of the member devices 102a and 102b can be any type of computer memory or any other type of electronic storage medium that is located either internally or externally to the member device 102a or 102b, such as, for example, read-only memory (ROM), compact disc read-only memory (CDROM), electro-optical memory, magneto-optical memory, erasable programmable read-only memory (EPROM), and electrically-erasable programmable read-only memory (EEPROM), or the like.

According to exemplary embodiments, the corresponding RAM can contain, for example, a web browser application for the member devices 102a or 102b. The web browser application typically will communicate with the hybrid social network service provider computing system 104 to allow a member operating a member device 102a or 102b to access and participate in, a particular hybrid social network hosted by the hybrid social network service provider computing system 104.

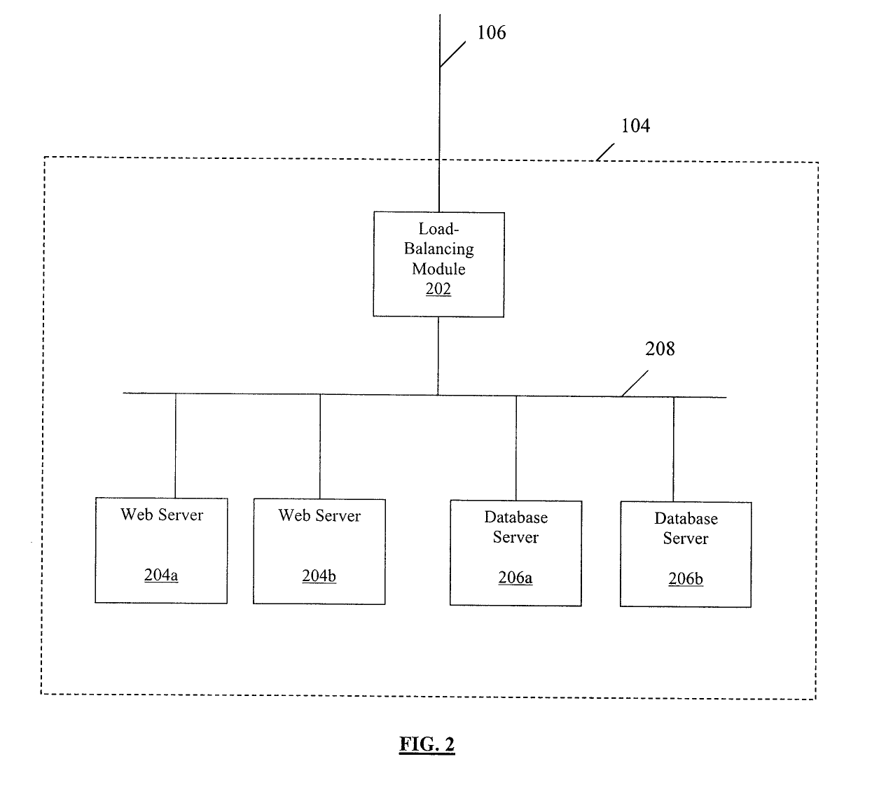

The hybrid social network service provider computing system 104 hosts one or more hybrid social networks. The hybrid social network service provider computing system 104 typically includes a web server to receive and respond to hybrid social network requests made by the web browser of a member device 102a and 102b. An exemplary hybrid social network service provider computing system 104 will be described in greater detail in reference to FIG. 2.

The network 106 may be a local area network (LAN), a wide area network (WAN), the Internet, analog or digital wired and wireless telephone networks (e.g. a Public Switched Telephone Network (PSTN), an Integrated Services Digital Network (ISDN), or a Digital Subscriber Line (xDSL)), or any other wired or wireless network. The network 106 may include multiple networks or subnetworks, each of which may include, for example, a wired or wireless communications channel.

Reference is now made to FIG. 2, in which an exemplary embodiment of the hybrid social network service provider computing system 104 of FIG. 1 is illustrated. In the exemplary embodiment shown in FIG. 2, the hybrid social network service provider computing system 104 includes a load balancing module 202, a number of web servers, and a number of database servers connected via a local network 208. For clarity, two web servers 204a and 204b and two database servers 206a and 206b have been illustrated.

The load-balancing module 202 is responsible for managing all communications between the member devices 102a and 102b, the web servers 204a and 204b, and the database servers 206a and 206b. Specifically, the load balancing module 202 receives requests from a particular device (member device 102a or 102b, web server 204a or 204b, or database server 206a or 206b) and selects the server (web server 204a or 204b, or database server 206a or 206b) which can best handle the request. The load-balancing module 202 determines which server can best handle the request by monitoring the following for each server (web servers 204a and 204b and database servers 206a and 206b): (a) connection count, (b) CPU usage, and (c) any failures. In monitoring these three aspects of each server, the load-balancing module 202 can select the server to give the member the best available experience in browsing a particular hybrid social network.

For example, the load balancing module 202 typically receives requests for data from members via member devices 102a and 102b, and web servers 204a and 204b. In response to a request, the load-balancing module 202 selects the appropriate web server 204a or 204b and/or database server 206a or 206b to handle the request. One of the objectives of the load-balancing module 202 is to distribute the load between the available servers, so that as many members can be served with the optimum performance. For example, when a member first attempts to access a particular hybrid social network, by entering in a specific website address in their web browser, for example, the load balancing module 202 will receive the access request and will send the request to one of the web servers 204a or 204b based on the current load of the system.

The load-balancing module 202 may be implemented in hardware or software. In a preferred embodiment, the load-balancing module 202 is implemented in a stand-alone hardware solution. The solution may include a Kemp LoadMaster 1500 with the option to add a hot standby for 99.999% availability. The LoadMaster 1500 typically includes a VIA Eden CPU, three 10/100 Mbps Auto-negotiation Ethernet ports which provide full duplex support at both 10 and 100 Mbps, a bootable flash disk, 512 MB DDR RAM, an external serial port and a 1U rack mount chassis made out of heavy-duty steel.

Keeping the load-balancing module 202 separate from the web servers 204a and 204b and the database servers 206a and 206b, not only stops the load-balancing from being a point of failure, but it also allows additional load balancing modules 202 to be easily added to the computing system 104 as required.

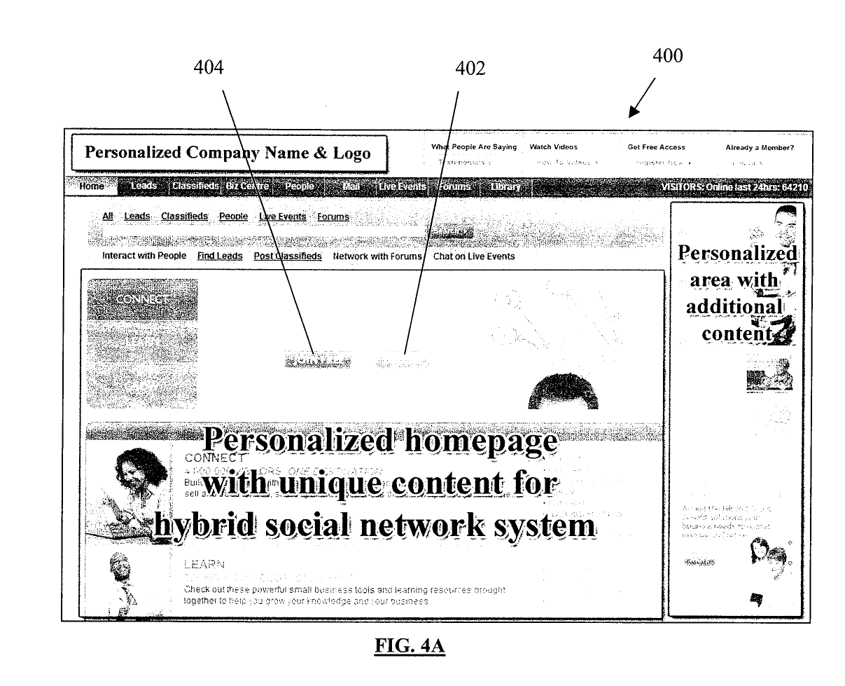

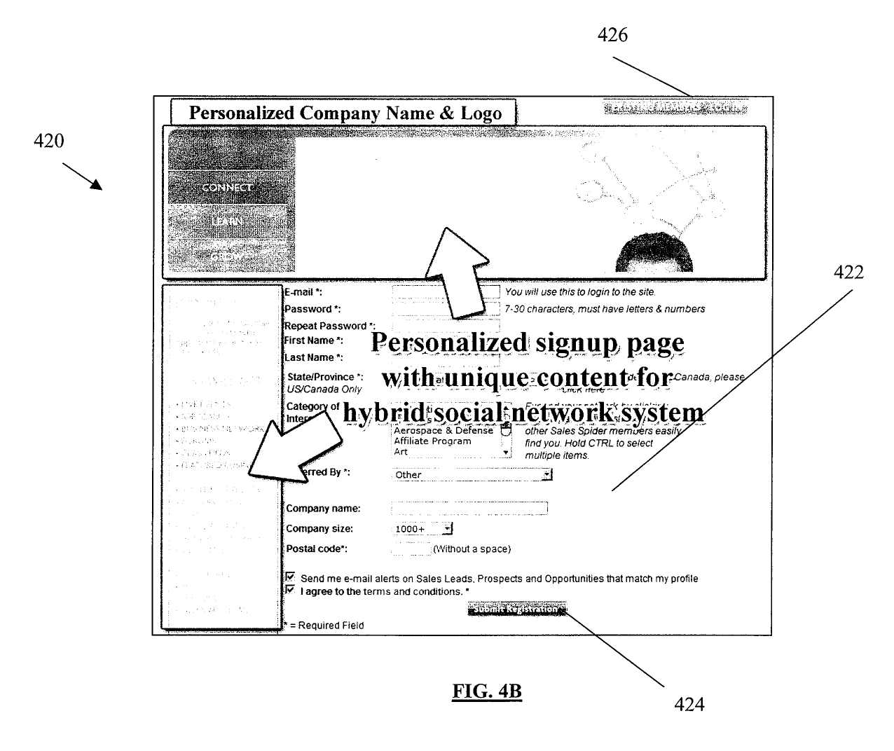

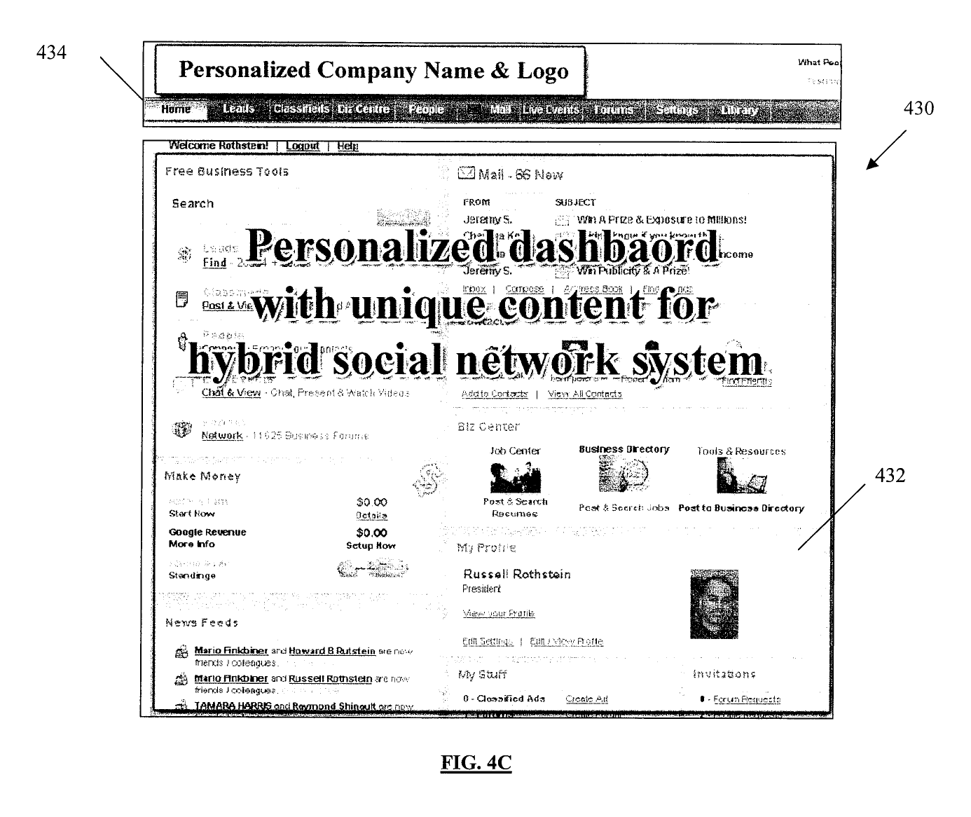

The web servers 204a and 204b receive HTTP requests from member devices 102a and 102b (via the load-balancing module 202), and in response, supply the requesting member device 102a or 102b (via the load-balancing module 202) with a web page based on the hybrid social network membership of the requesting member. Typically the web servers 204a and 204b include member interface (i.e. web page) configuration data for each hybrid social network. For example, the owner or corporate sponsor of a particular hybrid social network may have the option of configuring certain aspects of the member interface (e.g. color scheme, placement of logos) for the particular hybrid social network. The web servers 204a and 204b may then store these different configuration options. The member interface configuration options that may be available to hybrid social network owners or corporate sponsors will be described in further detail in relation to FIGS. 4A to 4C.

Each of the web servers 204a and 204b may be implemented using, for example, a general-purpose computer capable of responding to and executing instructions in a defined manner, a personal computer, a special purpose computer, a workstation, a server, a device, a component, or other equipment or some combination thereof capable of responding to and executing instructions.

The database servers 206a and 206b receive content requests from the web servers 204a and 204b (via load-balancing module 202), and supply the requested content to the requesting web server 204a or 204b (via load-balancing module 202) in response. Each of the database servers 206a and 206b includes a plurality of database tables to store the hybrid social network content. Typically there is one database table for each hybrid social network hosted by the hybrid social network service provider (referred to herein as a hybrid social network database table), and one common database table. Each of the hybrid social network database tables includes content that is specific to the associated hybrid social network. This may include content generated by the owner or corporate sponsor of the hybrid social network. The common database table, on the other hand, includes content that is common to all of the hybrid social networks. This may include user or member generated content, for example.

In other embodiments, the social network service provider computing system 104 may include only a single web server and a single database server. In these embodiments, all user or member requests would be communicated directly to the web server, and the web server and the database server would communicate directly, not through the load-balancing module.

The local network 208 may be a local area network (LAN), such as an Ethernet or Token Ring LAN.

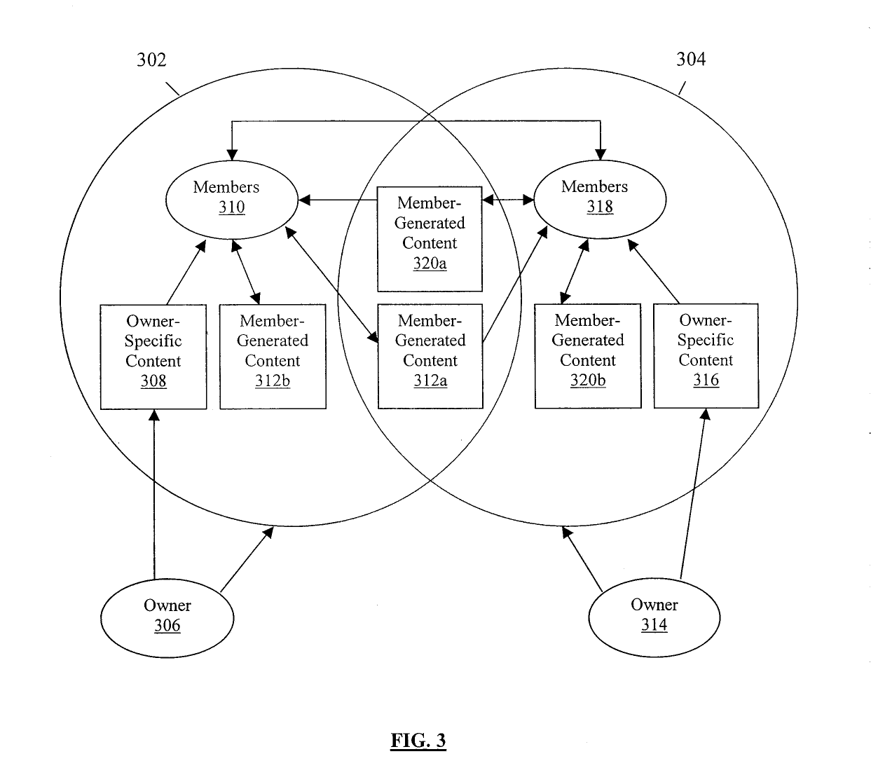

Reference is now made to FIG. 3, in which the distribution of content in the hybrid social network system 100 of FIG. 1 is illustrated by way of example. In the example shown in FIG. 3, a hybrid social network service provider hosts two separate and distinct hybrid social networks: a first hybrid social network 302 and a second hybrid social network 304.

The first hybrid social network 302 is associated with a first owner or corporate sponsor 306. The first owner 306 will typically have the ability to configure the member interface (i.e. web page or web pages) to the first hybrid social network 302. The configuration options available to the owner or corporate sponsor will be discussed in further detail in relation to FIGS. 4A to 4C.

The first owner or corporate sponsor 306 may also generate owner-specific content 308. The first hybrid social network 302 is also associated with one or more members 310. As will be discussed below, to become a member, a user must register with the hybrid social network service provider. The members 310 may also generate content 312a and 312b, referred to as member-generated or user-generated content. In most cases the member-generated content 312a and 312b is more valuable than the owner-specific content 308. In some embodiments, such as the embodiment shown in FIG. 3, a portion of the member generated content 312b may be specific to the first hybrid social network 302, and another portion of the member generated content 312a may be common or shared between all of the hybrid social networks 302 and 304. In other embodiments the entire member generated content 312b and 312a will be common or shared between all of the hybrid social networks 302 and 304.

The second hybrid social network 304 is associated with a second owner or corporate sponsor 314. The second owner 314 will typically have the ability to configure the member interface (i.e. web page or web pages) to the second hybrid social network 304. The configuration options available to the owner or corporate sponsor will be discussed in further detail in relation to FIGS. 4A to 4C. The second owner or corporate sponsor 314 may also generate owner-specific content 316.

The second hybrid social network 304 is also associated with one or more members 318. The members 318 of the second hybrid social network 304 may also generate content 320a and 320b, referred to as member-generated or user-generated content. In some embodiments, such as the embodiment shown in FIG. 3, a portion of the member generated content 320b may be specific to the second hybrid social network 304, and another portion of the member generated content 320a generated by members of the second hybrid social network 304 may be common or shared between all of the hybrid social networks 302 and 304. In other embodiments the entire member generated content 320b and 320a will be common or shared between all of the hybrid social networks 302 and 304.

In a hybrid social network, according to the embodiment described herein, the members 310 and 318 of a particular hybrid social network not only have access to the owner-specific content 308 and 316 generated by the corresponding owner or corporate sponsor 306 and 314, and the member-generated content 312a and 312b and 320a and 320b generated by members of the particular hybrid social network to which they belong, but they also have access to at least a portion of the member-generated content 312a and 320a generated by members of a another hybrid social network. In addition, in a hybrid social network, the members 310 and 318 of a particular hybrid social network can communicate, not only with members of the same hybrid social network, but also with members of another hybrid social network, where the hybrid social networks are preferably hosted by the same hybrid social network service provider.

In the example shown in FIG. 3, the members 310 of the first hybrid social network 302 can communicate, not only with other members 310 of the first hybrid social network 302, but they can also communicate with members 318 of the second hybrid social network 304. In addition, the members 310 of the first hybrid social network 302 have access, not only to the owner-specific content 308 and member-generated content 312a and 312b generated by the first owner 306 and members 310 respectively, but they also have access to a portion of the member-generated content 320a generated by the members 318 of the second hybrid social network 304.

This sharing of members and member-generated content helps alleviate some of the disadvantages associated with starting up new social networks. Typically, a newly generated social network is devoid of content and members. This causes a problem in attracting new members, because without members or member generated content, the social network may be considered valueless. Typically, the core value in a social network offering is the ability to interact with others in a social setting. Consequently, without any members, there may be little or no value. Some corporations have attempted to fill their new social networks with prefabricated content for new members to see, but typically, the only content that is considered valuable is content created or provided by other members.

By sharing members and content across hybrid social networks according to an embodiment of the present invention, a newly launched social network has the ability to instantly offer new users or members a pre-populated base of members, and user or member generated content. Moreover, it ensures that the user-generated content and the network membership are continuously updated and enhanced. Even if a hybrid social network does not have its own unique new users or content in a given day, the sharing of members and content ensures the vibrancy of the community and the attractiveness of their own unique audience.

In addition, by combining the member and content sharing with the ability to configure or brand the social network allows a company to uniquely associate its brand with its social network. In this way, new users or members of the hybrid social network will see the active community and user-generated content and associate it with the corporation's hybrid social network.

As discussed above, the owner or corporate sponsor of a particular hybrid social network may have the ability to configure the member interface (i.e. web page or web pages) of the particular social network. This allows the owner or corporate sponsor to meet the specific needs of both the brand and target audience.

Reference is now made to FIGS. 4A to 4C, in which exemplary member interface configuration options in accordance with an embodiment are illustrated. In the embodiment shown in FIGS. 4A to 4C, the member interface is a set of web pages that are configurable by the owner or corporate sponsor of the hybrid social network. In this embodiment, the set of web pages includes at least a general home page, a registration page and a member home page. Some of the configurable options available to the owner or corporate sponsor may be applicable to all of the web pages associated with a particular hybrid social network. These configuration options will be referred to as general configuration options. For example, the owner or corporate sponsor of the hybrid social network may be able to select a particular color scheme that will be applied to all web pages for the particular hybrid social network. Similarly, the owner or corporate sponsor may be able to select a logo or image that is to appear on every web page in a predetermined position or positions (e.g. in the headers and boarders).

Reference is now made to FIG. 4A, in which an exemplary general home page 400 is illustrated. The general home page 400 is typically the first web page the member or potential member is presented with upon attempting to access a particular hybrid social network. The general home page 400 is fully customizable by the owner or corporate sponsor of the hybrid social network. A general home page 400 typically includes at least a login button 402 and a registration button 404.

The login button 402, when activated, takes the user to a login page. The login page allows the user to login to the hybrid social network. Logging in typically involves providing information (e.g. username and password) that identifies and authenticates the user as a member. The registration button 404, when activated, takes the user to a registration page 420. The registration page 420 allows a potential member to become a member of the hybrid social network. The registration page 420 will be described in further detail with reference to FIG. 4B.

In some embodiments the general home page 400 may also include a section that indicates the number of visitors to the hybrid social network in the last 24 hours. The general home page 400 may also include content that the owner or corporate sponsor wants to make publicly available.

Reference is now made to FIG. 4B, in which an exemplary registration page 420 is illustrated. The registration page 420 provides a mechanism to allow potential members to become members of the hybrid social network. The registration page 420 typically includes a new member information section 422, a submit button 424 and a login button 426. However, in some embodiments, the registration page 420 may include other sections and action buttons as desired.

Most social networks require a potential member to provide certain personal information before a potential member can be registered as a member of the social network. The new member information section 422 of the registration page 420 typically lists the required information and provides means for the potential member to provide the required information to the hybrid social network. The type of information required from potential members is configurable by the owner or corporate sponsor of the hybrid social network. As shown in FIG. 4B the required information may include the e-mail address of the potential member, a password, the first and last name of the potential member, the state or province in which the potential member resides, and identification of categories of interest. Other information, such as a postal code or ZIP code, may also be requested. In some embodiments, the information collected from the members is provided to the owner or corporate sponsor of the hybrid social network for analysis and reporting purposes.

Reference is now made to FIG. 4C, in which an exemplary member home page 430 is illustrated. The member home page 430 is typically the first page the member is taken to after logging in to the hybrid social network. The member home page 430 acts as a jumping off point to other areas of the social network. The member home page 430 may include two main sections—a dashboard 432 and a menu bar 434. Both the dashboard 432 and the menu bar 434 are navigation tools that provide the member with access to different areas or features of the social network. In some cases the dashboard 432 and the menu bar 434 will provide access to at least some of the same areas or features of the hybrid social network. In other cases the dashboard 432 and the menu bar 434 will provide access to different areas and features of the hybrid social network. Both the dashboard 432 and the menu bar 434 may be fully customizable by the owner or corporate sponsor.

The menu bar 434 typically includes a plurality of tabs that when activated by the member, take the member to a different area of the hybrid social network. The following is a list of typical tabs that may be found on the menu bar 434: (1) Home; (2) Leads; (3) Classifieds; (4) Biz Tools; (5) Business Directory; (6) Job Center; (7) People; (8) Mail; (9) Live Events; (10) Forums; (11) News; and (12) Settings. The owner or corporate sponsor of a hybrid social network may choose to include, all, none or some of these tabs on the menu bar 434. Each of the typical tabs will be described below.

The Home tab, when activated, typically takes the user to their home page 430.

The Leads tab, when activated, typically takes the user to an area of the hybrid social network where the member is provided with free sales leads and prospects. This is an area of the hybrid social network that may be updated daily. In some cases the leads may be localized for members based on their geographic region. The leads section may give the member the option of signing up for an electronic newsletter reporting new leads and opportunities. Such a newsletter may be sent out weekly or daily.

The Classifieds tab, when activated, typically takes the user to a free classified advertisement board that provides local classifieds and forums for jobs, housing, for sale items, personals, services, local community and events. The classified ads may be localized for members based on their geographic region. The classifieds section may give members the option of signing up for an electronic newsletter reporting, for example, the number of new classifieds along with general titles of the new classifieds. Such a newsletter may be sent out weekly or daily. When both the classifieds electronic newsletter and the leads electronic newsletter are sent out on a weekly basis, the system may be set up to send them out on different days of the week so as to avoid clogging the member's inbox on any particular day.

The Biz Tools tab, when activated, typically takes the user to an online business tool area that includes business tools such as calculators, business documents, financing and grants, business start-up guides, list of business laws and regulations, online training and videos.

The Business Directory tab, when activated, typically takes the user to an online business directory area of the hybrid social network. The business directory area may be where business owners and entrepreneurs can get free advertising and post their business product or service for free. The business directory area may also allow members to find products and services.

The Job Center Tab, when activated, typically takes the user to a job center area of the hybrid social network. The job center allows members to post their resumes and have them reviewed by potential employers. In addition, employers and recruiters can post job advertisements, and search and connect with potential employees.

The People Tab, when activated, typically takes the user to an area of the hybrid social network where business owners and entrepreneurs can build networks. This area may provide profiles, a directory and listings of business owners, entrepreneurs and distributors.

The Mail tab, when activated, typically takes the user to an area of the hybrid social network where members can exchange messages with other members. As discussed above, members of a particular hybrid social network can communicate not only with other members of the particular hybrid social network, but they can also communicate (e.g. exchange messages) with members of other hybrid social networks hosted by the same service provider.

The Live Events tab, when activated, typically takes the user to an area of the hybrid social network where they can participate in live events. Examples of live events that may be available to members include live chats and live videos. The live chats may be implemented through chat rooms, which would allow members to have immediate live interactions with other members. Similar to the mail area described above, the live chats are not limited to members of the same hybrid social network, but may take place between members of any hybrid social network hosted by the same service provider. The live videos may include business videos that fall into one of two categories: (1) videos from news organizations such as MSNBC and SBTV (small business TV); or (2) user uploaded videos which are business-related videos provided by members to be viewed by other members.

The Forum tab, when activated, typically takes the user to an area where they can participate and/or create business forums on various subjects. The member who creates the forum typically has editorial control over the forum. While the owner or corporate sponsor may only have the option of including or removing many of the other tabs from the menu bar 434, the owner or corporate sponsor may be given further configuration options with respect to the forums tab. For example, the owner or corporate sponsor may be given the option to create their own forum topics and limit all other forums from its members. This allows the owner or corporate sponsor to control the quality of the forums. In this case the owner or corporate sponsor typically has editorial control over their forums.

The News tab, when activated, typically takes the user to a news section of the hybrid social network where members may be provided with articles and press releases related to the owner or corporate sponsor.

The final common tab is the Settings tab, which, when activated, typically takes the user to an area of the hybrid social network where the user can customize certain settings. For example, the settings area may be used to allow the member to control their profile listing, opt in and out of privileges, and adjust all other personal settings. The Settings tab is not typically removed from the menu bar 434.

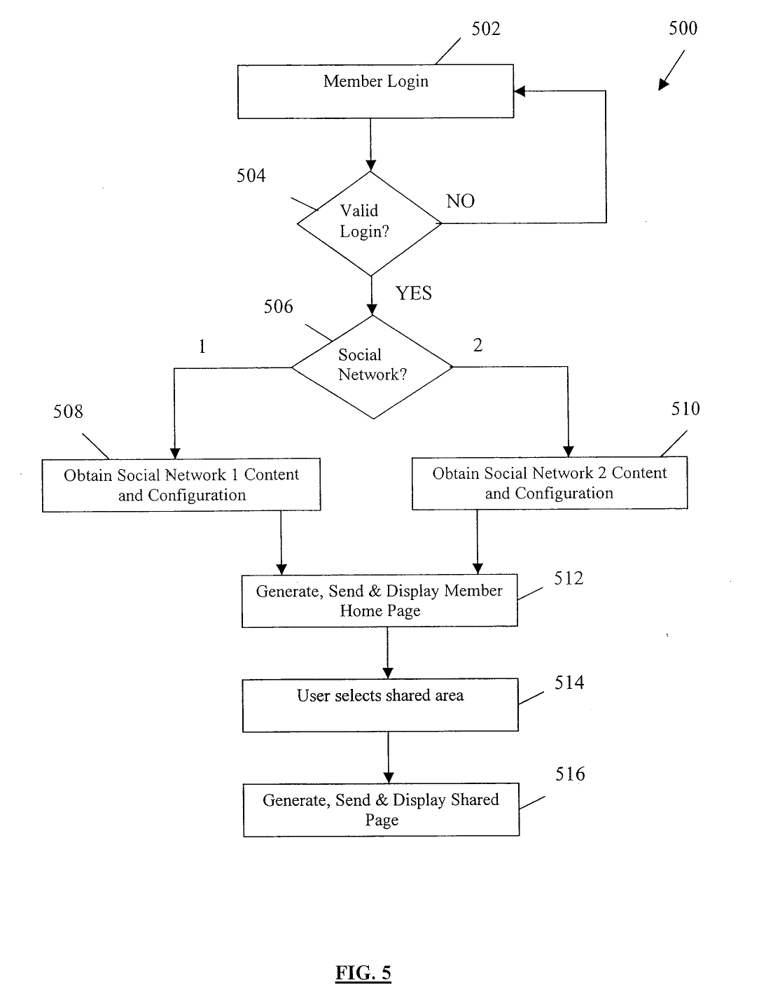

Reference is now made to FIG. 5, in which a method 500 for delivering content to a member of a hybrid social network is illustrated. At step 502 a member, using a member device 102a or 102b, for example, is provided a login page for a hybrid social network by a hybrid social network service provider. As described above, the member may have requested the login page from the hybrid social network service provider by selecting the login button on either the general home page or the registration page. The login page will typically include any of the general configuration options selected by the owner or corporate sponsor of the hybrid social network. For example, the login page may have a particular color scheme or contain a company logo as desired by the owner or corporate sponsor.

The member will enter the required login information (e.g. a username and password) and the member device 102a or 102b will transmit the login information to the hybrid social network service provider computing system 104 via network 106.

At diamond 504, the login information is received by the hybrid social network service provider computing system 104. The hybrid social network service provider computing system 104 then determines if the login information is valid or correct. If the login information is incorrect then the method proceeds back to step 502. Specifically the user is returned to the login page where they are asked to re-enter their login information. If the login information is correct or valid then the method proceeds to diamond 506.

At diamond 506, the hybrid social network service provider computing system 104 uses at least a portion of the login information (e.g. username) to determine which hybrid social network the member belongs to. In this embodiment of the method 500, the hybrid social network provider hosts two distinct hybrid social networks. However, in other embodiments, the single hybrid social network service provider may host any suitable number of hybrid social networks. If the hybrid social network service provider computing system 104 determines that the member belongs to the first hybrid social network, then the method proceeds to step 508. If the hybrid social network service provider computing system 104 determines that the member belongs to the second hybrid social network, then the method proceeds to step 510.

At step 508, the hybrid social network service provider computing system 104 obtains the general configuration options (e.g. color scheme, logos), the navigation configuration options (e.g. the menu bar 434 settings) and the hybrid social network-specific content for the first hybrid social network. As discussed above, the general configuration option and the navigation configuration options may be stored by the web servers 204a and 204b, and the network-specific content may be stored by the database servers 206a and 206b. The method then proceeds to step 512.

At step 510, the hybrid social network service provider computing system 104 obtains the general configuration options (e.g. color scheme, logos), the navigation configuration options (e.g. the menu bar 434 settings) and the hybrid social network-specific content for the second hybrid social network. As discussed above, the general configuration options and the navigation configuration options may be stored by the web servers 204a and 204b, and the network-specific content may be stored by the database servers 206a and 206b. The method then proceeds to step 512.

At step 512, the hybrid social network service provider computing system 104 uses the retrieved general configuration options, the navigation configuration options, and the social network-specific content to generate the member home page 430. The hybrid social network service provider then transmits the generated member home page 430 to the member device 102a or 102b. The member device 102a or 102b receives the member home page 430 and displays it to the member. At this point the member is now participating in the hybrid social network.

At step 514, the member selects one of the shared areas of the hybrid social network using the menu bar 434, for example. The shared areas of the hybrid social network may include those areas where the user can communicate with other members (e.g. the Mail area or the Live Events (Live Chat) area) and those areas where the user is provided with or has access to content generated by other members (e.g. the Forum area described above). The shared areas of the hybrid social network are important as they allow members of separate social networks to interact with each other.

The member device 102a or 102b sends a request, via network 106, to the hybrid social network service provider computing system 104 for the information for the selected shared area.

At step 516, the hybrid social network service provider computing system 104 receives the request and retrieves the user-generated content associated with the selected shared area. As described above, the user or member generated content may be stored by the database servers 206a and 206b in a general or common database table. Once the appropriate member-generated content is retrieved, the hybrid social network service provider computing system 104 uses the retrieved member-generated content, the general configuration options retrieved in step 508 or 510, and the navigation configuration options retrieved in step 508 or 510 to generate a web page for the selected shared area. The generated web page is then sent to the member device 102a or 102b via network 106.

The member device 102a or 102b receives the web page and displays it to the member.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A social network system, the system comprising:
at least one computer adapted to provide content to a first plurality of members and a second plurality of members, wherein a first portion of the content is associated with a first social network and a second portion of the content is associated with a second social network;
wherein the first social network is associated with a first entity, and the first plurality of members, wherein the first portion of the content comprises a first member-generated content; and
wherein the second social network is associated with a second entity and the second plurality of members, wherein the second portion of the content comprises a second member-generated content, and
wherein the computer is adapted to provide to the first plurality of members: (i) the first member-generated content, and (ii) at least a portion of the second member-generated content.

2. The social network system of claim 1, wherein the computer is adapted to enable communication between the second plurality of members and the first plurality of members.

3. The social network system of claim 1, wherein the computer is adapted to display to the first plurality of members owner-specific content generated by the first entity.

4. The social network system of claim 1, wherein the first plurality of members have access to all of the second member-generated content.

5. The social network system of claim 3, wherein the computer is adapted to display to the second plurality of members: (i) the second member-generated content, and (ii) at least a portion of the first member-generated content.

6. The social network system of claim 5, wherein the computer is adapted to display to the second plurality of members owner-specific content generated by the second entity.

7. The social network system of claim 6, wherein the computer further comprises:
a) at least one web server; and
b) at least one database server adapted for communication with the web server;
wherein the at least one web server is adapted to respond to requests for the content;
wherein the at least one database server is adapted to store the content.

8. The social network system of claim 7, wherein the at least one web server further comprises a plurality of web servers and the computer further comprises a load balancing module adapted for communication with the plurality of web servers and the at least one database server, wherein the load balancing module is adapted to select one of the plurality of web servers for response to a request for the content.

9. The social network system of claim 7, further comprising a member device associated with one of the first plurality of members, wherein the member device is adapted to send a request for the content to the web server and to display the content received from the web server.

10. The social network system of claim 7, wherein the at least one database server is adapted to implement: a first database table, a second database table, and a common database table, wherein the first database table is adapted to store the owner-specific content generated by the first entity, wherein the second database table is adapted to store the owner-specific content generated by the second entity, and wherein the common database table is adapted to store at least one of the first member-generated content and the second member-generated content.

11. A method of providing content to a user, the method comprising:
a) receiving identifying information from the user;
b) using the identifying information to identify the user as a member of a first social network, wherein the first social network is associated with a first member-generated content; and
c) sending to the user the first member-generated content from the first social network and at least a portion of a second member-generated content associated with a second social network.

12. The method of claim 11, wherein step (c) further comprises sending to the user owner-specific content generated by a first entity, wherein the first entity is associated with the first social network.

13. The method of claim 12, wherein the identifying information is received from a member device of the user.

14. The method of claim 13, wherein the identifying information comprises login information.

15. The method of claim 14, wherein step (b) further comprises using at least a portion of the login information to identify the user as a member of the first social network.

16. The method of claim 15 further comprising displaying on the member device the first member-generated content from the first social network and at least a portion of a second member-generated content associated with a second social network.

17. A method of accessing content by a user, the method comprising:
a) sending a request for content to a computer, wherein the request comprises identifying information, wherein the identifying information is adapted to identify the user as a member of a first social network, wherein the first social network is associated with a first member-generated content; and
b) receiving on a member device of the user the first member-generated content from the first social network and at least a portion of a second member-generated content associated with a second social network.

18. The method of claim 17, further comprising displaying on the member device the content received in step (b).

19. The method of claim 18, wherein step (b) further comprises receiving an owner-specific content generated by a first entity, wherein the first entity is associated with the first social network.

20. The method of claim 19, wherein the request comprises login information, wherein the login information identifies the user as a member of the first social network.
